(19) United States
(12) Patent Application Publication
(10) Pub. No.: US 2010/0306016 A1
(43) Pub. Date: Dec. 2, 2010

(54) PERSONALIZED TASK RECOMMENDATIONS

(75) Inventors: John A. Solaro, Bellevue, WA (US); Brian P. Walker, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/472,793

(22) Filed: May 27, 2009

(51) Int. Cl. G06Q 10/00; G06Q 50/00

(52) U.S. Cl. 705/9; 705/7; 705/11

(57) ABSTRACT

Personalized task recommendation technique embodiments are presented that involve recommending a particular task or tasks to a user which can be employed in furtherance of a desired goal based on observations of past users and how they accomplished this goal. The workflow that is recommended to a user is personalized in that it takes into account the demographic characteristics of the user and the workflow tasks they use. This involves grouping the aforementioned past users into groups whose users accomplish a particular goal using a similar workflow and exhibit similar demographic characteristics. A new user wishing assistance in completing a particular goal is then associated with the group having similar demographic and workflow choice characteristics to the new user. A workflow based on the workflows of the associated group is then recommended to the new user.

### BACKGROUND

Many community and commercial web applications provide schemes to assist a user in completing a goal of some type. For example, in the context of an educational website, a user can be guided in how to research and prepare a paper on a scholarly topic.

### SUMMARY

This Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

Personalized task recommendation technique embodiments described herein generally involve recommending a particular task or tasks to a user that can be employed in furtherance of a desired goal based on observations of past users and how they accomplished this goal. The past users are chosen to be similar to each other in the manner in which they pursue the desired goal, as well as in their demographic characteristics. The tasks recommendations are personalized in that the user has demographic characteristics and/or workflow task choices which are similar with those of the group of past users.

In one exemplary embodiment, recommending one or more tasks for use in furthering a goal, involves first inputting a sequence of workflow tasks performed by an individual in furtherance of the desired goal in to a computer. This is repeated for multiple individuals. In addition, demographic information about each individual is input. The workflow and demographic data is used to establish groups of individuals. Each group exhibits a prescribed degree of workflow similarity between members in connection with furthering the desired goal and exhibits a prescribed degree of similarity in demographic information among the members.

Once the groups have been established, a user's request for assistance in accomplishing at least a portion of the desired goal can be input. The user will then be asked to provide certain demographic information. In addition, the user will be asked to identify any workflow tasks he or she performed in furtherance of the goal, or if the user is being monitored these workflow tasks will automatically be captured. Once the user's demographic information and/or previously performed workflow tasks are received and input, this data is employed to identify which of the previously established groups include members who are most similar to the user. One or more workflow task recommendations are then provided to the user. These tasks are based on the workflow tasks employed by the members of the group found to be most similar to the user, and are designed to assist the user in accomplishing at least a portion of the desired goal.

### DESCRIPTION OF THE DRAWINGS

The specific features, aspects, and advantages of the disclosure will become better understood with regard to the following description, appended claims, and accompanying drawings where:

FIG. 1 is a flow diagram generally outlining one embodiment of a process for grouping users based on workflow and demographics.

FIG. 2 is a flow diagram generally outlining one embodiment of a process for recommending one or more workflow tasks to a user for use in furthering a goal.

FIG. 3 is a diagram depicting a general purpose computing device constituting an exemplary system for implementing personalized task recommendation technique embodiments described herein.

### DETAILED DESCRIPTION

In the following description of personalized task recommendation technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

### 1.0 Personalized Task Recommendations

The personalized task recommendation technique embodiments described herein are directed toward recommending a particular task or tasks to a user that can be employed in furtherance of a desired goal. In general, the task or tasks (which can be referred to as a workflow) recommended to the user are based on observations of past users and how they accomplished the desired goal.

The workflow that is recommended to a user is personalized in that it takes into account the demographic characteristics of the user and the workflow tasks they have taken. In general, this involves grouping the aforementioned past users into groups whose users accomplish a particular goal using a similar workflow and exhibit similar demographic characteristics. A new user wishing assistance in completing the particular goal is then associated with the group having similar demographic characteristics to the new user. A workflow based on the workflows of the associated group is then recommended to the new user.

The foregoing manner in which a workflow recommendation is personalized to a user based on workflows used by similar users is very advantageous because a wide variance in the skill level between users could make less personalized recommendations of little value. For example, in the context of an educational goal, such as writing an article on Civil War battles, the tasks performed by a grade school student in researching and writing the paper would be very different from a graduate student at university. A workflow tailored for a grade school student would be much too rudimentary to be of use to the graduate student, and a workflow tailored to the graduate student would be much too complex for the grade school student. Further, a generic workflow compiled from the workflows of users of varying levels might be too complex for the grade school student and too rudimentary for the gradate student

### 1.1 Grouping of Past Users

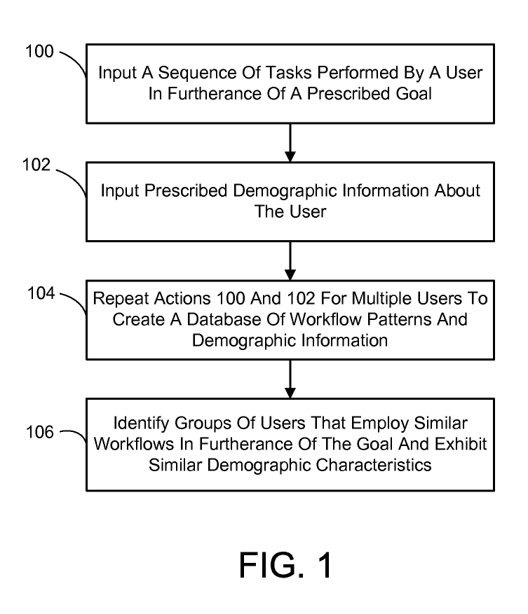

In one embodiment, the grouping of past users based on their workflows in working toward a particular goal and their demographics is accomplished as illustrated in FIG. 1. First, a sequence of tasks performed by a user in furtherance of a prescribed goal is input into a computer (100), such as any of the computing devices described in the computing environment section provided later in this disclosure. If the user is performing the tasks on a computer via a computer network (such as the Internet or a proprietary intranet), the workflow can be monitored using the network to obtain the desired information. Otherwise the workflow can be captured separately and input to the computer implementing the grouping effort. Next, prescribed demographic information about the aforementioned user is input to the computer implementing the grouping effort (102). This can be accomplished in many ways. For example, if the user is in communication with the aforementioned computer network, information about the demographic characteristics of the user can be gleaned from the what is already known to the network about the user, and/or by presenting the user with a request for the information (such as via a questionnaire). If this is not possible, the information can be captured separately then input to the computer implementing the grouping effort. Actions 100 and 102 are then repeated for multiple users to create a database of workflow patterns and demographic information, as shown in action 104. The number of users needed for each prescribed goal will vary with the application. Groups could be created dynamically based purely on user actions or they could be pre-defined, determined ahead of time. Dynamic groups need at least 3 users in order to create a suggestion. Pre-defined groups are created before there is any user database—therefore require no minimum users.

Once data has been gathered from enough users, groups of users that employ similar workflows in furtherance of a goal, and exhibit similar demographic characteristics, are identified (106). For instance, in the educational example described previously, for the goal of researching and writing an article, a group might be identified whose members are like-minded grade school students, while another group might be identified whose members are like-minded graduate students. While not shown in FIG. 1, in an embodiment employing pre-defined groups, step 104 would be skipped and the characteristics gathered in 100 and 102 are used to place the user in a pre-defined group.

In regard to the demographics used for both grouping the past users and associating a new user to a group, a variety of characteristics can be employed. For example, in an educational context some of the factors can be:

a) type of user (such as student, teacher, school administrator, and so on);
b) subject of study (such as math, history, music, and so on);
c) class teacher's name;
d) type of school (such as grade school, high school, university, and so on);
e) grade level;
f) location of the class (such as what school or university); and
g) time of the class.

The foregoing examples are not intended to be complete, but just a sampling of the demographic characteristics that can be used for grouping past and new users in an educational context. Further, other factors can apply to applications not having an educational context. Generally, the personalized task recommendation technique embodiments described herein can be implemented for any application in which a sequence of tasks is performed in furtherance of a goal. The demographic characteristics employed would be tailored to the specific application.

It is further noted that the demographic characteristics involved in grouping past and new users can be modified at any time. When a characteristic is added, modified or deleted, the past users can be re-grouped depending on the availability of any new data needed for the regrouping effort. The demographics input for any new user could then be conformed to the new set of characteristics.

The grouping of past users can also be updated each time a new user's demographics and workflow pattern for a goal are available to the implementing computer. Generally, the new user's data would be added to that of the past users, and the user groups would be regrouped.

In regard to the method employed to group the past users for a particular goal based on their workflows and demographics, many different conventional grouping techniques can be employed. In one implementation, the workflow and demographic data is used to identify common traits among user or the tasks, and use these traits to group the users. For instance, the traits can include, but are not limited to, personality (e.g., a student learner type may be visual learner vs. hands-on learner), or the type of project the workflow represents (e.g., a research paper vs. presentation), or the technology required to complete the task (e.g., presentation software as compared to a word processor).

### 1.2 Recommending Workflow Tasks

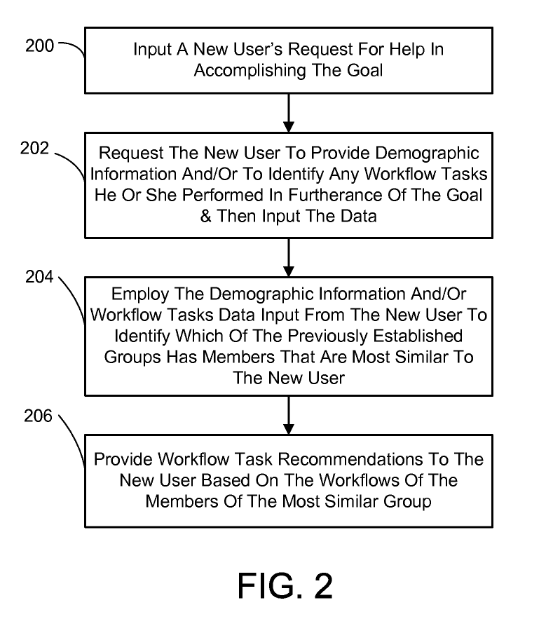

In one embodiment, the recommendation of a workflow task or tasks to a new user in connection with a particular goal (that has a group associated with it), is accomplished as illustrated in FIG. 2. First, the new user's request for help in accomplishing the goal is input to the computer implementing the recommendation scheme (200). This request could take the form of a specific request from the user for help such as clicking a “help” link, the system could make a determination that help would be useful to a user given a certain amount of time since the last user action, or any other way the user asks or system makes a determination it is useful for the user to receive a workflow or task suggestion. It is noted that the request could be for the tasks needed to complete the goal, or for some portion of the goal. In response, the new user is asked to provide demographic information and/or to identify any workflow tasks he or she performed in furtherance of the goal (202). Once the user's demographic information received and input, this data is employed to identify which of the previously established groups include members who are most similar to the user. The demographic information can be the same information gleaned or input in association with the previously described grouping effort. The demographic information and/or previously performed workflow task data input from the new user is then employed to identify which of the previously established groups associated with the goal under consideration has members that are most similar to the new user (204). Many different methods can be employed to identify the most similar group. For example, in one implementation a user may be considered most similar to an existing group based on meeting a certain percent of similarity to the group. In this example implementation, all members in a group may have 10 demographic data points to describe them, and the user in question has 7 of the same demographic data points, meeting a prescribed minimum bar of 70 percent. In another implementation, if a group of users employed the same tasks for a workflow and a user has previously performed a prescribed percentage of the same tasks in furtherance of a goal, that user would be considered similar to the group. In yet another implementation the user would be requested to choose the group they feel is most similar. It is noted that while these examples would be appropriate methods, they are not the only ones.

The requested workflow tasks recommendations are then provided to the new user based on the workflows of the members of the most similar group (206). As the workflow patterns of members within a group may not be identical depending on the grouping methods employed, the workflow tasks recommended to the user may not be the exact tasks employed by all the past users, but instead tasks based on a compilation of the workflows of the group members. Here again, many different methods can be employed to compile the past user workflows. For example, in a dynamic group, a probability technique could be employed. More particularly, suppose a minimum prescribed percent of past users in the group had task Y as the next task in series. In such a case, task Y is deemed to be next task and is suggested to a user. This prescribed percentage could also be variable and changed as desired. In a pre-defined group, the “past” user workflows would simply be the ones defined up front, or added over time as desired. It is noted that here again the foregoing examples would be appropriate methods, but not the only ones.

In regard to identifying which previously established groups associated with a goal under consideration has members that are most similar to a new user, it is noted that the degree of similarity needed to associate the new user to a group, regardless of the similarity-determining method employed, can vary. For example, the minimum similarly measure needed to associate the new user to a group can vary depending on the context of the desired goal. In addition, if it is determined that the new user is not similar enough to any groups under a current minimum similarity measure, the minimum measure can be increased by a prescribed degree.

### 2.0 The Computing Environment

A brief, general description of a suitable computing environment in which portions of the personalized task recommendation technique embodiments described herein may be implemented will now be described. The technique embodiments are operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

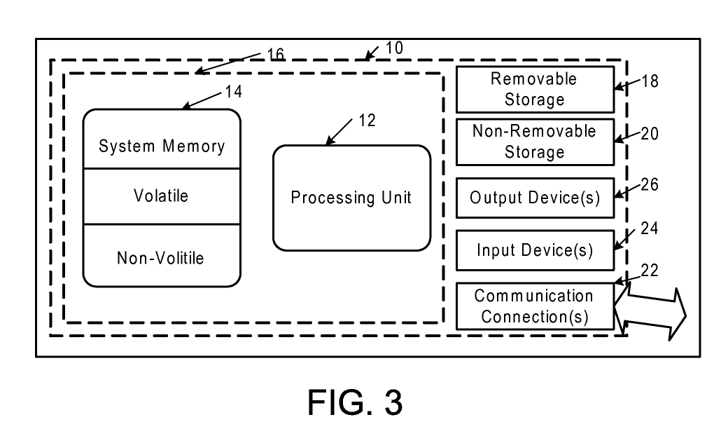

FIG. 3 illustrates an example of a suitable computing system environment. The computing system environment is only one example of a suitable computing environment and is not intended to suggest any limitation as to the scope of use or functionality of personalized task recommendation technique embodiments described herein. Neither should the computing environment be interpreted as having any dependency or requirement relating to any one or combination of components illustrated in the exemplary operating environment. With reference to FIG. 3, an exemplary system for implementing the embodiments described herein includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated in FIG. 3 by dashed line 16. Additionally, device 10 may also have additional features/functionality. For example, device 10 may also include additional storage (removable and/or non-removable) including, but not limited to, magnetic or optical disks or tape. Such additional storage is illustrated in FIG. 3 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Device 10 may also have input device(s) 24 such as keyboard, mouse, pen, voice input device, touch input device, camera, etc. Output device(s) 26 such as a display, speakers, printer, etc. may also be included. All these devices are well know in the art and need not be discussed at length here.

The personalized task recommendation technique embodiments described herein may be further described in the general context of computer-executable instructions, such as program modules, being executed by a computing device. Generally, program modules include routines, programs, objects, components, data structures, etc. that perform particular tasks or implement particular abstract data types. The embodiments described herein may also be practiced in distributed computing environments where tasks are performed by remote processing devices that are linked through a communications network. In a distributed computing environment, program modules may be located in both local and remote computer storage media including memory storage devices.

### 3.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for grouping users based on workflow and demographics, comprising:
using a computer to perform the following process actions:
inputting a sequence of tasks comprising said workflow performed by each user in furtherance of the same prescribed goal;
inputting prescribed demographic information about said users; and
identifying groups of users, wherein each group employs a prescribed degree of workflow similarity in furtherance of said prescribed goal and exhibits a prescribed degree of similarity in demographic information.

2. The process of claim 1, wherein said users perform workflow tasks on a computer which is in communication with a computer network, and wherein the process action of inputting the sequence of tasks comprising said workflow performed by each user in furtherance of the same prescribed goal, comprises an action of monitoring the workflow performed by each user via the computer network.

3. The process of claim 1, wherein said users perform workflow tasks on a computer which is in communication with a computer network, and wherein the process action of inputting prescribed demographic information about said users, comprises an action of obtaining at least some of said demographic information from what is already known to the network about the users.

4. The process of claim 1, wherein said users perform workflow tasks on a computer which is in communication with a computer network, and wherein the process action of inputting prescribed demographic information about said users, comprises the actions of:
presenting each user with a questionnaire via the computer network which asks the user to provide at least some of said demographic information; and
receiving the demographic information provided by the users in response to the questionnaire via the computer network.

5. The process of claim 1, wherein said goal is an educational-based goal, and wherein the process action of inputting prescribed demographic information about said users, comprises inputting information concerning whether the user is a student, or a teacher, or a school administrator.

6. The process of claim 1, wherein said goal is an educational-based goal, and wherein the process action of inputting prescribed demographic information about said users, comprises inputting information concerning the user's subject of study.

7. The process of claim 1, wherein said goal is an educational-based goal, and wherein the process action of inputting prescribed demographic information about said users, comprises inputting information concerning the name of the user's teacher.

8. The process of claim 1, wherein said goal is an educational-based goal, and wherein the process action of inputting prescribed demographic information about said users, comprises inputting information concerning the type of school the user attends.

9. The process of claim 1, wherein said goal is an educational-based goal, and wherein the process action of inputting prescribed demographic information about said users, comprises inputting information concerning the grade level of the user.

10. The process of claim 1, wherein said goal is an educational-based goal, and wherein the process action of inputting prescribed demographic information about said users, comprises inputting information concerning the location of the user's school.

11. The process of claim 1, further comprising the actions of:
inputting additional demographic information about said users after the user groups have been identified; and
regrouping the users, wherein each new group employs a prescribed degree of workflow similarity in furtherance of said prescribed goal and exhibits a prescribed degree of similarity in the expanded demographic information.

12. The process of claim 1, further comprising the actions of:
modifying or reducing the existing demographic information about said users after the user groups have been identified; and
regrouping the users, wherein each new group employs a prescribed degree of workflow similarity in furtherance of said prescribed goal and exhibits a prescribed degree of similarity in the modified or reduced demographic information.

13. The process of claim 1, further comprising the actions of, after the user groups have been identified:
inputting a sequence of tasks comprising said workflow performed by each of one or more additional users in furtherance of the prescribed goal;
inputting prescribed demographic information about the one or more additional users; and
regrouping the users to include the one or more additional users, wherein each new group employs a prescribed degree of workflow similarity in furtherance of said prescribed goal and exhibits a prescribed degree of similarity in demographic information.

14. A computer-implemented process for recommending one or more workflow tasks to a user for use in furthering a goal, comprising:
using a computer to perform the following process actions:
inputting the user's request for help in accomplishing at least a portion of said goal;
requesting the user to provide prescribed demographic information and inputting the requested information when received;
employing the received demographic information to identify which of a previously established number of user groups comprise members that are most similar to the user, wherein members of each group exhibits a prescribed degree of workflow similarity between members in connection with furthering said goal and exhibits a prescribed degree of similarity in demographic information among the members; and
providing one or more workflow tasks to the user, which are based on the workflow tasks employed by the members of the group identified as comprising members most similar to the user, in accomplishing the at least said portion of the goal.

15. The process of claim 14, wherein the process action of employing the received demographic information to identify which of the previously established number of user groups comprise members that are most similar to the user, comprises the actions of:
whenever it is determined that the user is not similar enough to any of the groups based on a prescribed minimum similarity measure to associate a user to a group, increasing the prescribed minimum similarly measure by a prescribed degree;
re-employing the received demographic information to identify which of a previously established number of user groups comprise members that are most similar to the user based on the increased prescribed minimum similarly measure.

16. The process of claim 14, wherein the process action of requesting the user to provide prescribed demographic information, comprises an action of requesting the same demographic information employed in part to establish the user groups.

17. The process of claim 14, wherein the process action of providing one or more workflow tasks to the user which are based on the workflow tasks employed, by the members of the group identified as comprising members most similar to the user, in accomplishing the at least said portion of the goal, comprises the actions of:
compiling the workflow tasks employed by the members of the group identified as comprising members most similar to the user in accomplishing the at least said portion of the goal, to establish one or more group workflow tasks to be employed in accomplishing the at least said portion of the goal; and
providing the one or more group workflow tasks established to accomplish the at least said portion of the goal, to the user.

18. A computer-readable storage medium having computer-executable instructions stored thereon for recommending one or more workflow tasks for use in furthering a goal, said computer-executable instructions comprising:
for each of a number of individuals,
inputting a sequence of workflow tasks performed by the individual in furtherance of said goal,
inputting prescribed demographic information about the individual;
establishing groups of individuals, wherein each group exhibits a prescribed degree of workflow similarity between members in connection with furthering said goal and exhibits a prescribed degree of similarity in demographic information among the members;
inputting a user's request for assistance in accomplishing at least a portion of said goal;
requesting the user to provide said prescribed demographic information or workflow choice characteristics, and inputting the requested information when received;
employing the received information to identify which of the previously established groups comprise members who are most similar to the user; and
providing one or more workflow tasks to the user, which are based on the workflow tasks employed by the members of the group identified as comprising members most similar to the user, to accomplish the at least said portion of the goal.

19. The computer-readable storage medium of claim 18, further comprising instructions for:
revising the demographic information about said users after said groups have been established, wherein the demographic information is revised by at least one of adding new information or deleting existing information or modifying existing information; and
regrouping the users, wherein each new group employs a prescribed degree of workflow similarity in furtherance of said prescribed goal and exhibits a prescribed degree of similarity in the revised demographic information.

20. The computer-readable storage medium of claim 18, further comprising instructions for:
after the groups have been established,
inputting a sequence of tasks comprising workflow performed by each of one or more additional users in furtherance of the prescribed goal,
inputting prescribed demographic information about the one or more additional users, and
regrouping the users to include the one or more additional users, wherein each new group employs a prescribed degree of workflow similarity in furtherance of said prescribed goal and exhibits a prescribed degree of similarity in demographic information.
